(19) United States
(12) Patent Application Publication
(10) Pub. No.: US 2013/0290062 A1
(43) Pub. Date: Oct. 31, 2013

(54) PAVING COORDINATION METHOD AND SYSTEM

(71) Applicants: Sanjaykumar R. Patel, Bristow, VA (US); Glenn Christopher Bramer, Fairfax, VA (US); Jeroen Snoeck, Louisville, CO (US)

(72) Inventors: Sanjaykumar R. Patel, Bristow, VA (US); Glenn Christopher Bramer, Fairfax, VA (US); Jeroen Snoeck, Louisville, CO (US)

(73) Assignee: TRIMBLE NAVIGATION LIMITED, Sunnyvale, CA (US)

(21) Appl. No.: 13/456,690

(22) Filed: Apr. 26, 2012

(51) Int. Cl. G06Q 10/06

(52) U.S. Cl. CPC G06Q 10/06313
USPC 705/7.23

(57) ABSTRACT

A system for implementing a method of coordinating activities associated with paving a roadway with a paver which receives batches of paving material transported to it by transport trucks from a paving material plant where the batches of paving material are prepared, includes computer systems on the paver, on one or more transport trucks, at the paving material plant, and a server having communication links to the computer system on the paver, the computer system on one or more transport trucks, and the computer system at the paving material plant. The server communicates with the computer systems on the paver, on one or more trucks, and at the plant over communication links to provide coordinated operation of the paver, trucks and plant so that the paving material produced by the plant is delivered to the roadway and applied in a manner by the paver that is efficient.

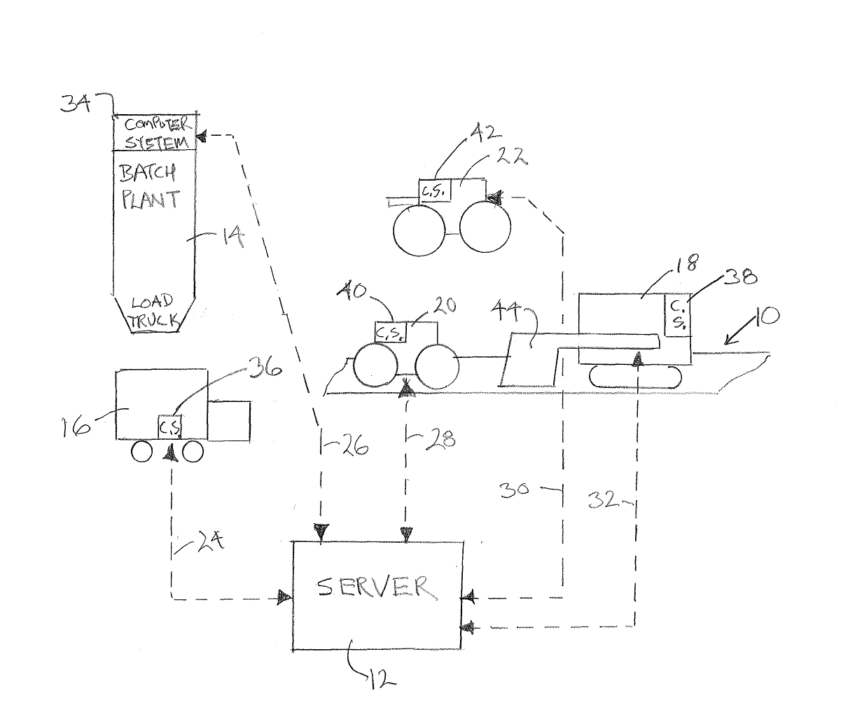

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

This relates to a system and method for coordinating the various operations that must be performed to surface a roadway or other area with paving material. Typically, paving material, such as asphalt concrete or Portland cement concrete, is prepared at a plant that is located near to the portion of the roadway that is to be paved. With either asphalt concrete or Portland cement concrete, it is important that the material be applied to the road promptly after it is made at the plant. The paving material is made in batches at the plant, and transported by truck to the roadway. If the batch of paving material remains in the truck too long, it will not be usable by the paving equipment. Further, the quality of the paved surface may not be as good as desired if the paving operation is not carried out promptly. It is therefore undesirable for trucks filled with paving material to be lined up at the paving location, waiting to be unloaded into a paving machine. On the other hand, the costs associated with the paving equipment and the personnel who operate the paving equipment are significant, and it is undesirable for the equipment and personnel to be idle for periods of time after each batch of paving material is used, waiting for the truck delivery of the successive batches of paving material.

It is also desired to be able to keep track of the conditions and location under which each batch of paving material is applied to the roadway, the truck which transports the material, and the paving material plant where each batch of material is made. This may become important in the event that the paved road is defective in some respect, affecting both quality control and responsibility for repair. It is also important to keep track of certain information for each batch produced by each plant, such as material characteristics, truck number, load weight, and load time, and delivery information, such as delivery time and material characteristics at jobsite arrival approved by the paving contractor.

### SUMMARY

A computer-based method of coordinating activities associated with paving a roadway is implemented by a server. A paver receives batches of paving material transported to it by transport trucks from a paving material plant where the batches of paving material are prepared. The server performs a series of steps and communicates with the paver, the transport trucks, and the paving material plant. Some or all of these steps can be performed and they can be performed in any order or sequence. The server receives a communication from the load paver, indicating a need for a batch of paving material. The server communicates to the paving material plant the need for a batch of paving material. The server receives a communication from the paving material plant, indicating that a batch of paving material has been produced. The server communicates to a transport truck the need to transport the batch of paving material to the roadway. The server receives a communication from the transport truck, indicating that the batch of paving material has been picked up at the paving material plant by the transport truck. The server receives a communication from the plant as to the characteristics of the load, also called the ticket information. The server communicates the ticket information to the paver. During transport, the server continually communicates to the paver, indicating the expected ETA of the transport truck and variable characteristics of the material, e.g. temperatures. The server receives a communication from the transport truck, indicating that the batch of paving material has been delivered to the roadway or other surface to be paved, such as an airport or a commercial surface. The server receives a communication from the paver, indicating that the paving material has been deposited on the roadway. These steps are repeated during the paving operation.

The step of receiving a communication from the transport truck, indicating that the batch of paving material has been delivered to the roadway, may include the step of receiving a communication from the transport truck indicating the quantity and the quality of the batch of paving material delivered. The step of receiving a communication from the paver, indicating that the paving material has been deposited on the roadway, may include the step of receiving a communication from the paver, that indicates the location on the roadway on which the batch of paving material was deposited. When the paving material is asphalt material, the compactors will communicate to the server, telling the server the asphalt temperature measured for each compaction pass and the number of compaction passes in each area. The server will communicate to the compactors, providing the compactors a map of the latest temperatures as laid by the paver and as rolled by all compactors.

The step of receiving a communication from the paver, indicating that the paving material has been deposited on the roadway, includes the step of receiving a communication from the paver, indicating the condition of the batch of paving material at the time that it was deposited on the roadway. The step of communicating to the paver, indicating that the transport truck is in route to the roadway may include the step of communicating to the paver, indicating the estimated time of arrival of the transport truck at the roadway.

A system for implementing the computer-based method of coordinating activities associated with paving a roadway with a paver which receives batches of paving material transported to it by transport trucks from a paving material plant where the batches of paving material are prepared, includes a computer system on the paver, a computer system on each of the transport trucks, a computer system at the paving material plant, and a server. The server has communication links to the computer system on the paver, the computer system on each of the transport trucks, and the computer system at the paving material plant. The server receives a communication from the paver, indicating a need for a batch of paving material. The server communicates to the paving material plant this need, and receives a communication from the paving material plant, indicating that a batch of paving material has been produced. The server communicates to a transport truck the need to transport the batch of paving material to the roadway. The server receives a communication from the transport truck, indicating that the batch of paving material has been picked up at the paving material plant by the transport truck, and indicating its estimated time of arrival. The server receives a communication from the plant as to the characteristics of the load, also called ticket information. The server communicates the ticket information to the paver. During transport the server continually communicates to the paver, indicating the expected ETA of the transport truck and variable characteristics of the material, e.g. temperature. The server receives a communication from the transport truck, indicating that the batch of paving material has been delivered to the roadway or other surface to be paved. The server receives a communication from the paver, indicating that the paving material has been deposited on the roadway.

The server may receive a communication from the transport truck indicating the quantity and the quality of the batch of paving material delivered. The server may receive a communication from the paver, indicating the location on the roadway on which the batch of paving material was deposited. The server may receive a communication from the paver, indicating the condition of the batch of paving material at the time that the paving material is deposited on the roadway.

### BRIEF DESCRIPTION OF THE DRAWING

The FIGURE is a diagrammatic representation of the equipment and facilities that are used in a paving operation, and is useful in explaining the embodiments.

### DETAILED DESCRIPTION

Reference is made to the FIGURE, which illustrates diagrammatically an embodiment of the system for implementing a computer-based method of coordinating activities associated with paving a roadway 10. The FIGURE is additionally useful in explaining the method by which the system operates.

The system includes a server 12 which may be located at a location that is remote from the paving material plant 14, remote from the transport trucks, as exemplified by truck 16, that convey the paving material from the plant 14 to the roadway 10, remote from the roadway 10 which is being paved or resurfaced, and remote from the equipment including paver 18, and compactors 20 and 22. Alternatively, the server 12 may also be located at any of these locations, including plant 14, or the site where the paving is taking place. The server 12 may be located anywhere that is desired.

The server 12 typically will be a general purpose computer which is configured and programmed to provide communication among the system components. Each of the system components has a communication link, represented by dashed lines 24, 26, 28, 30, and 32, which provides bidirectional communication with the server 12. Each communication link may be established with any of a number of devices. For example, each of the system components may include a Trimble SNM940 modem. The SNM940 modem establishes communication through Wi-Fi, if available. If Wi-Fi is not available, then the SNM940 modem establishes a communication link through a cellular connection. Each of the system components includes at least one computer system that communicates over the associated communication link with the server 12. The paving material plant 14 includes a computer system 34, each truck 16 includes a computer system 36, the paver 18 includes a computer system 38, and the compactors 20 and 22 include computer systems 40 and 42, respectively. Computer systems 34-42 may typically be control systems that accomplish display and control functions on these components.

The system implements a computer-based method of coordinating activities associated with paving roadway 10 with paver 18. Paver 18 receives batches of paving material transported to it by transport trucks 16 from the paving material plant 14 where batches of paving material are prepared. The plant 14 may produce batches of Portland cement concrete from Portland cement, sand, crushed rock, water, and other additives. Alternatively, the plant 14 may produce batches of asphalt concrete from bitumen, aggregate and other additives. In either instance, the paving material is prepared in batches, each of which is transported to the roadway 10 by means of one or more trucks 16.

A truck 16 delivers a quantity of paving material to the paver 18 which then spreads the paving material over the prepared surface, with the thickness of the material being controlled by a screed 44 which is pulled over the material by the paver. If the paving material is asphalt concrete, one or more compacting machines 20 and 22 travel over the asphalt cement on the roadbed and compact the material to a desired degree. It is important that the paving material be used by the paver 18 as soon as it is delivered to the paving location so that it is deposited on the roadway before it cures or sets up and, in the case of asphalt concrete, while it is sufficiently warm that it can be compacted. Further, it is also important that there not be extended periods during which the paver 18 and other associated equipment are idle while waiting for the delivery of additional paving material, as this would significantly reduce the amount of paving that can be accomplished with the paving equipment and as it would decrease the bonding with an earlier laid, colder surface. It is also desirable that the system keep track of the location on the roadway where each truckload of paving material is deposited, and the conditions of the paving material at the time that this occurs. The server 12 facilitates achieving both of these objectives.

The server 12 receives a communication from the load paver 18 over link 32, indicating a need for a batch of paving material. This communication may be manually initiated by the foreman at the load paver 18 or by the operator of the load paver providing an input to the computer system 38. Alternatively, the paver 18 may include level sensors in the paver material storage bin which sense the use of the paving material and trigger the computer system 38 to send such a communication to the server 12 before all of the paving material is used. The server 12 then communicates to the computer 34 at the paving material plant 14 over the link 26 the need for a batch of paving material. As the batch of paving material nears readiness for use by the paver 18, the computer system 24 communicates to the server 12 that a batch of paving material has been produced, or will shortly be produced shortly. The server 12 receives this communication from the paving material plant computer 34 and then communicates to a transport truck 16 the need to transport a batch of paving material to the roadway 10. The computer 36 is illustrated as being physically located on the truck 16; however, this need not be the case. Computer system 36 may be located at a remote location and be linked by radio, cellular connection, or otherwise, to the truck 16 and, if desired, to multiple trucks. After a truck 16 travels to the plant 14 and a batch, or a portion of a batch, of paving material is loaded onto truck 16, the computer 36 transmits to the server 12, and the server 12 receives a communication from the transport truck 16, indicating that the batch of paving material has been picked up at the paving material plant by the transport truck. The server 12 then communicates to the paver 18, indicating that the transport truck 16 is in route to the roadway 10. This communication may also include the estimated time of arrival of the truck. Next, the server 12 receives a communication from the transport truck, indicating that the batch of paving material has been delivered to the roadway 10. This communication may be initiated by the driver of the truck or may be generated automatically by the computer system 36 in conjunction with a GPS receiver on the truck 16, monitoring the movement of the truck and determining when the truck 16 has arrived at the roadway 10. The server 12 receives the communication from the transport truck 16, indicating that the batch of paving material has been delivered to the roadway. This communication may also indicate the quantity and the quality of the batch of paving material delivered, including for example the temperature of the material. Finally, the paver 18 may transmit and the server 12 may receive a communication indicating that the paving material has been deposited on the roadway 10. This communication may also include the location on the roadway 10 where the batch of material was deposited. The paver 18 may include a number of sensors that sense the temperature of the paving material as it is applied to the roadway, ambient temperature, width of the asphalt screed or concrete pan, speed of the paver, thickness of the material laid and other relevant conditions and productivity information. This information may also be transmitted to the server 12. The server 12 may compile a complete record of the roadway paving operation, keeping track of the plant from which each batch of paving material was obtained, in the case of multiple supply sources, and also keeping track of the conditions under which each batch of paving material was used to pave the roadway. Finally, the compacting machines 20 and 22 are operated to compact the paving material on the roadway in the instance of asphalt concrete, and the computer systems 20 and 22 communicate this activity to the server 12 via links 28 and 30. The server 12 keeps track of the operation of the compacting machines 20 and 22 over the roadway 10. It will be appreciated that the communication from the compacting machines 20 and 22 to the server provides the temperature of the asphalt measured for each compaction pass and the number of each compaction passes in the area. The server communicates to the compactors, providing a map of the most recent temperatures, as laid by the paver and as rolled by all of the compactors. This process may be repeated with a communication to the server 12, indicating the need for another batch of paving material.

It will be appreciated that the goal of the system is to implement a computer-based method to coordinate the paving activities of the plant, the transport truck or trucks, the paver and paving equipment, and compaction equipment, if applicable, resulting in coordinated operation of the machines at maximum efficiency and maintaining a record of machine operation. The various communications to paving components and paving material plant may be made in such a way as to give an appropriate lead time for accomplishing a task, with the goal in mind of providing paving material at the right time to the paving equipment.

What is claimed is:

1. A computer-based method of coordinating activities associated with paving a roadway with a paver which receives batches of paving material transported to it by transport trucks from a paving material plant where the batches of paving material are prepared, said method being implemented by a server which performs the following steps and communicates with the paver, the transport trucks, and the paving material plant, comprising the steps of:
receiving a communication from the load paver, indicating a need for a batch of paving material,
communicating to the paving material plant the need for a batch of paving material,
receiving a communication from the paving material plant, indicating that a batch of paving material has been produced, or will be produced shortly,
communicating to a transport truck the need to transport the batch of paving material to the roadway,
receiving a communication from the transport truck, indicating that the batch of paving material has been picked up at the paving material plant by the transport truck,
communicating to the paver, indicating that the transport truck is in route to the roadway,
receiving a communication from the transport truck, indicating that the batch of paving material has been delivered to the roadway, and
receiving a communication from the paver, indicating that the paving material has been deposited on the roadway.

2. The method of claim 1, in which the step of receiving a communication from the transport truck, indicating that the batch of paving material has been delivered to the roadway, includes the step of receiving a communication from the transport truck indicating the quantity and the quality of the batch of paving material delivered.

3. The method of claim 1 in which the step of receiving a communication from the paver, indicating that the paving material has been deposited on the roadway includes the step of receiving a communication from the paver, indicating the location on the roadway on which the batch of paving material was deposited.

4. The method of claim 1 in which the step of receiving a communication from the paver, indicating that the paving material has been deposited on the roadway, includes the step of receiving a communication from the paver, indicating the condition of the batch of paving material at the time that it was deposited on the roadway.

5. The method of claim 4 in which the step of receiving communication from the paver includes the step of receiving information including the speed, width of screed, and thickness of the paving material.

6. The method of claim 1 in which the step of communicating to the paver, indicating that the transport truck is in route to the roadway includes the step of communicating to the paver, indicating the estimated time of arrival of the transport truck at the roadway.

7. A system for implementing a computer-based method of coordinating activities associated with paving a roadway with a paver which receives batches of asphalt paving material transported to it by transport trucks from a paving material plant where the batches of paving material are prepared, and in which compacting machines compact the asphalt material after it is deposited on the roadway, comprising
a computer system on the paver,
a computer system on each of the transport trucks and the compacting machines,
a computer system at the paving material plant, and
a server having communication links to the computer system on the paver, the computer system on each of the transport trucks, and the computer system at the paving material plant, said server
receiving a communication from the paver, indicating a need for a batch of paving material,
communicating to the paving material plant the need for a batch of paving material,
receiving a communication from the paving material plant, indicating that a batch of paving material has been produced, or will be produced shortly,
communicating to a transport truck the need to transport the batch of paving material to the roadway,
receiving a communication from the transport truck, indicating that the batch of paving material has been picked up at the paving material plant by the transport truck,
communicating to the paver, indicating that the transport truck is in route to the roadway,
receiving a communication from the transport truck, indicating that the batch of paving material has been delivered to the roadway, and
receiving a communication from the paver, indicating that the paving material has been deposited on the roadway.

8. The system of claim 7 in which the server receives a communication from the transport truck indicating the quantity and the quality of the batch of paving material delivered.

9. The system of claim 7 in which the server receives a communication from the paver, indicating the location on the roadway on which the batch of paving material was deposited.

10. The system of claim 7 in which the server receives a communication from the paver, indicating the condition of the batch of paving material at the time that it was deposited on the roadway.

11. The system of claim 10 in which the stop of receiving communication from the paver includes the step of receiving information including the speed, width of screed, and thickness of the paving material.

12. The system of claim 6 in which the server communicates to the paver, indicating the estimated time of arrival of the transport truck at the roadway.

13. The system of claim 12, further comprising the steps of receiving a communication from the compacting machines, providing the asphalt temperature for each compaction pass and the number of compaction passes in the area.

14. The system of claim 13, further comprising the step of receiving a communication from the compacting machines including the asphalt material temperature measured for each compaction pass, and the number of compaction passes in the area.
